(19) United States
(12) Patent Application Publication
(10) Pub. No.: US 2012/0175329 A1
(43) Pub. Date: Jul. 12, 2012

(54) Ladder Attachment

(76) Inventor: Douglas Eugene Johnson, Mena, AR (US)

(21) Appl. No.: 12/986,343

(22) Filed: Jan. 7, 2011

(51) Int. Cl. A47B 23/00; B23P 11/00; F16M 13/02

(52) U.S. Cl. 211/86.01; 29/428

(57) ABSTRACT

A ladder attachment having two trays connected by two supports. The connection of the two trays and two supports forms an internal hollow compartment. The two supports are attached to the two trays in a titled inwardly fashion, preferably forming an angle of 1-45°. Within this range, 15° is preferable because it corresponds to the pitch of a standard step ladder. The ladder attachment fits over the top of the step ladder whereby the internal compartment of the ladder attachment receives the step ladder.

### CROSS REFERENCE TO RELATED APPLICATIONS

Not applicable

### STATEMENT REGARDING FEDERALLY SPONSORED RESEARCH OR DEVELOPMENT

Not applicable

### BACKGROUND OF THE INVENTION

1. Field of the Invention

The present invention relates generally to ladder attachments, and more particularly, to a step ladder attachment to hold work materials.

2. Brief Description of the Related Art

Attachments to step ladders for purposes of holding work materials are well-known in the art. For example, U.S. Pat. No. 4,222,841 to Cillis teaches a single tray that is clamped to the side rail of a ladder. In addition, U.S. Pat. No. 7,264,084 to Switzer teaches a tray that attaches via elastic bands to the top step of a step ladder. The prior art attachments are often complex in design, and not easily attachable and detachable.

It would therefore be desirable to develop a step ladder attachment for purposes of holding and providing easy access to materials while working on a step ladder that is simple in design, and thus easier to manufacture, and that is easily attachable and detachable.

### BRIEF SUMMARY OF THE INVENTION

The present invention is directed to a ladder attachment comprising a first tray and a second tray, and a first support and a second support, wherein said first support and said second support are attached between said first tray and said second tray forming a hollow internal compartment, said compartment adapted to receive a step ladder in the open position.

The present invention is also directed to a method of attaching the ladder attachment to the ladder.

These and other features, objects and advantages of the present invention will become better understood from a consideration of the following detailed description of the preferred embodiments and appended claims in conjunction with the drawings as described below.

### BRIEF DESCRIPTION OF THE DRAWINGS

FIG. 1 is a perspective view of the ladder attachment attached to a step ladder in the open position.

FIG. 2 is a perspective view of the ladder attachment.

FIG. 3 is an elevational view of the ladder attachment.

FIG. 4 is a perspective view of the ladder attachment showing the tray covers attached and without the attachable third tray,

FIG. 5 is a cross sectional view along the line 5-5 of FIG. 4.

### DETAILED DESCRIPTION OF THE INVENTION

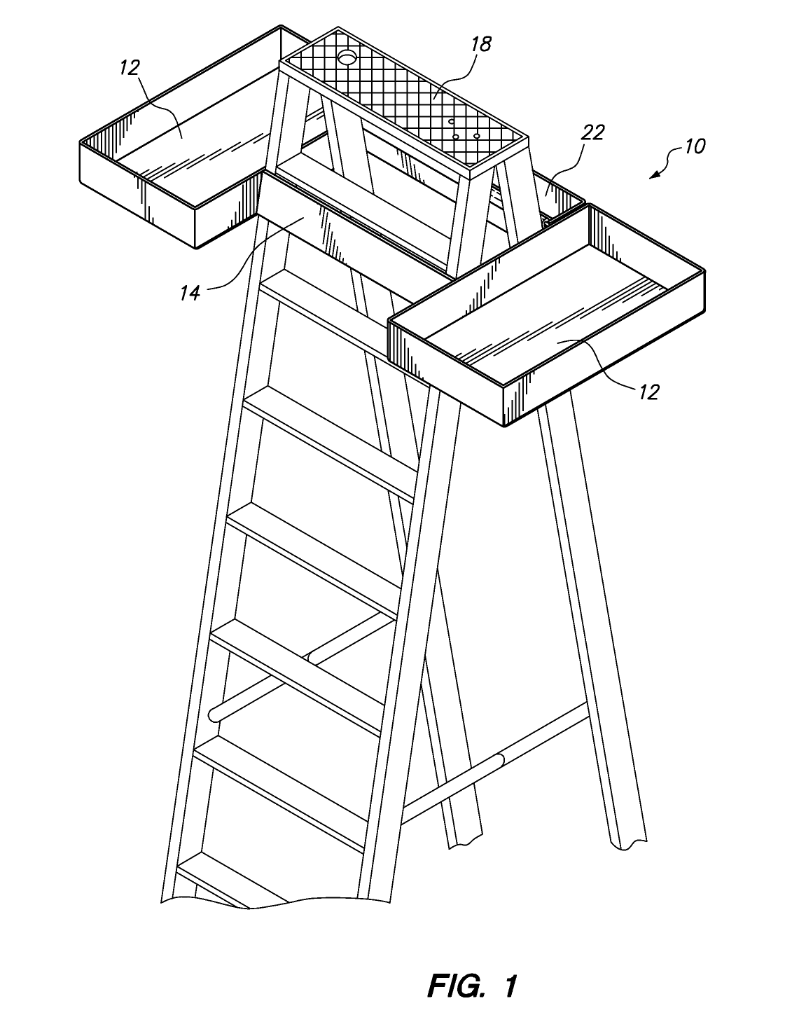

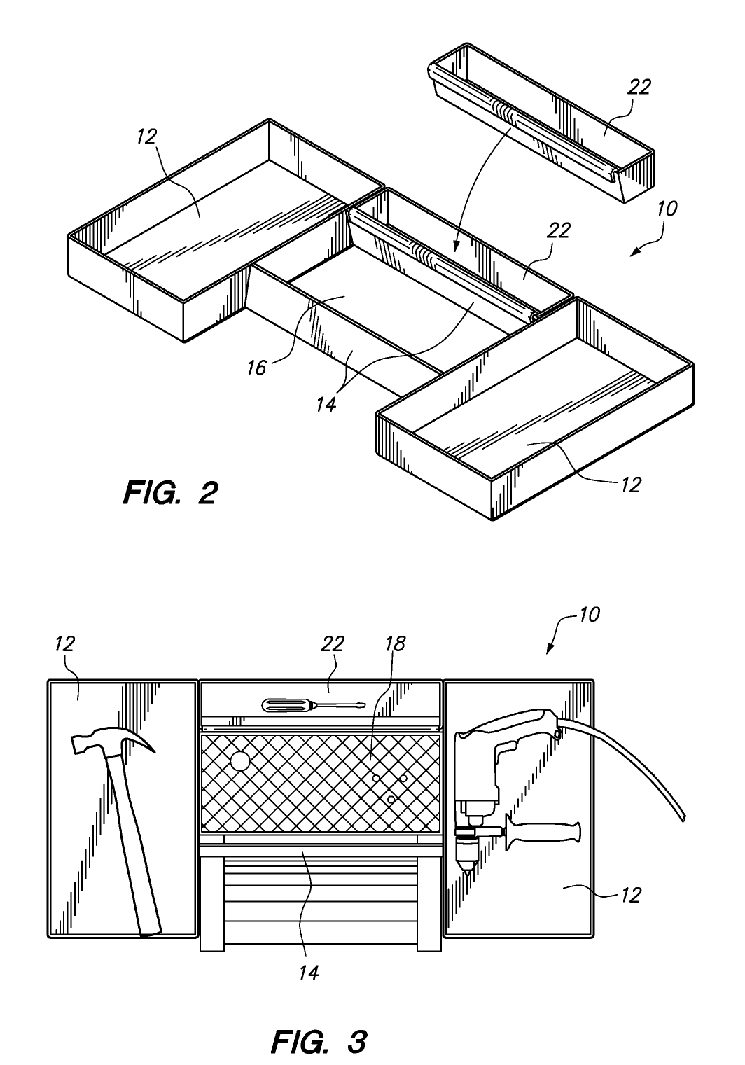

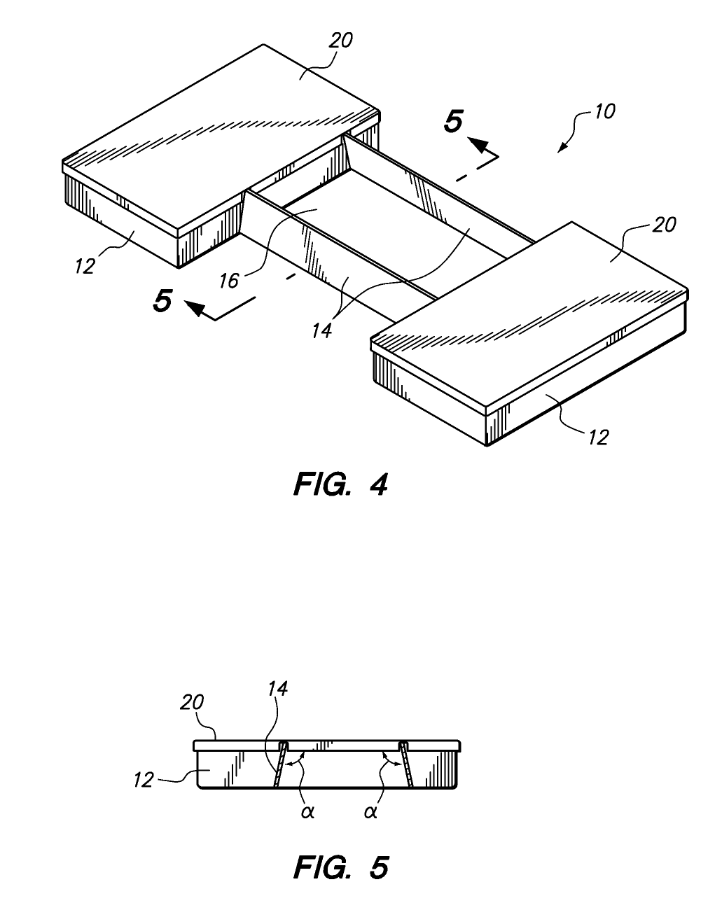

With reference to FIGS. 1-5, the preferred embodiment of the present invention may be described. The ladder attachment 10 is comprised of two trays 12. While the shape and dimensions of the tray 12 can vary, each tray 12 is preferably rectangular in shape with dimensions of 20″ in length and 10″ in width. Each tray 12 preferably has four vertically extending walls. Each wall is preferably 3 inches in height and ⅛ inch in width. The four corners of each tray 12 may also be rounded instead of pointed. The trays 12 are preferably made of plastic, but they may also be made of other durable, light weight materials well-known to those skilled in the art.

The two trays 12 are attached by two supports 14. While the dimensions of the supports 14 are variable, the supports 14 are preferably 14.5-15 inches in length, 3 inches in height. The supports 14 are preferably rectangular, but may also be cylindrical or any other suitable shape. The supports 14 are preferably made of the same material as the trays 12. The supports 14 can welded, bolted, or any means for connection that are well-known to those skilled in the art. When the supports 14 are attached to the two trays 12, a hollow internal compartment 16 is formed. The supports 14 are attached in a slightly inwardly tilted fashion, each forming an angle a with respect to the vertical axis of the compartment 16 in the range of 1-45°. Within this range, 15° is preferable since it corresponds to the pitch of standard step ladders. The compartment 16 is large enough for the ladder attachment to fit over the top of the step ladder 18. The first support 14 is preferably attached to the trays 12 at a distance of 4½-5¼ inches from the end of one of the longest sides of the trays 12. The second support 14 is preferably attached 14¾-16 inches from the same end of one of the longest sides of the trays 12.

The ladder attachment 10 also comprises two tray covers 20. The covers 20 are the same size as the trays 12 and preferably snap over each tray 12 through notches in the cover that are adapted to receive the supports 14. However, the means for connecting the covers 20 to the trays 12 is not so limited, and includes all means for connection known to those skilled in the art.

In addition, the ladder attachment 10 comprises a third tray 22. The third tray 22 has a lip along its length on one side. The lip of the third tray 22 releasably attaches to one of the supports 14. The third tray 22 is preferably the same height as the trays 12 (preferably 3 inches) and slightly shorter in length than that of the supports 14 (preferably 14 inches). The third tray 22 is preferably five inches in width.

The hollow internal compartment 16 of the ladder attachment 10 is adapted to slidably receive the step ladder 18. Step ladder 18 is one of the type well-known to those skilled in the art consisting of two legs hinged at their tops. Each leg of the step ladder 18 preferably has two side rails with rungs in between for climbing up and down. The step ladder 18 has an open and closed position. The closed position is when the legs of the step ladder 18 are parallel. Conversely, the open position is when the two legs of the step ladder 18 are spread apart. The ladder attachment 10 is slid over the top of the step ladder 18 in the open position. Once the ladder attachment 10 is placed over the top of the step ladder 18, the ladder attachment 10 slides down the side rails of the step ladder 18 until the side rails contact all four intersections of the trays 12 and supports 14. Based on the preferred dimensions of the trays and supports, the ladder attachment cannot slide down the ladder past approximately the top step. Thus, since it is warned not to use the top step of the ladder, none of the usable steps are interfered with. The ladder attachment fits flush to the side rails of the step ladder 18 because the pitch of the step ladder 18 corresponds to the attachment angles α of the supports 14 to the side of the trays 12, preferably 15°.

Once the ladder attachment 10 is attached to the step ladder 18, the user of the ladder can work on the ladder and have adequately surfaces for placing tools and supplies, such as tool boxes, hammers, drills, saws, and paint cans. The ladder attachment preferably can support 50-60 pounds. To remove the ladder attachment 10, the ladder attachment 10 can be lifted from its stationary position and pulled over the top of the step ladder 18.

1. A ladder attachment for a step ladder having two legs and an open and a closed position, comprising a first tray and a second tray, and a first support and a second support, wherein said first support and said second support are attached between said first tray and said second tray forming a hollow internal compartment, wherein said compartment is capable of slidably receiving the top of said step ladder in the open position.

2. The ladder attachment of claim 1 wherein each of said first support and said second support form an angle with the vertical axis of said interior compartment in the range of 1-45°.

3. The ladder attachment of claim 2 wherein said angle is 15°.

4. The ladder attachment of claim 1 further comprising a third tray, wherein said third tray is releasably attached to said first support.

5. The ladder attachment of claim 1 further comprising a first tray cover and a second tray cover, wherein said first tray cover attaches to said first tray and said second tray cover attaches to said second tray.

6. A method comprising placing a ladder attachment over the top of a step ladder comprising two legs and having an open and a closed position, wherein said ladder attachment comprises a first tray and a second tray, and a first support and a second support, wherein said first support and said second support are attached between said first tray and said second tray forming a hollow internal compartment, wherein said compartment is capable of slidably receiving the top of said step ladder in the open position.

7. The method of claim 6 wherein each of said first support and said second support form an angle with the vertical axis of the said interior compartment in the range of 1-45°.

8. The method of claim 7 wherein said angle is 15°.

9. The method of claim 6 wherein said ladder attachment further comprises a third tray, wherein said third tray is releasably attached to said first support.

10. The method of claim 6 wherein said ladder attachment further comprises a first tray cover and a second tray cover, wherein said first tray cover attaches to said first tray and said second tray cover attaches to said second tray.
